(19) United States
(12) Patent Application Publication
(10) Pub. No.: US 2010/0281159 A1
(43) Pub. Date: Nov. 4, 2010

(54) MANIPULATION OF DHCP PACKETS TO ENFORCE NETWORK HEALTH POLICIES

(76) Inventors: Christopher Boscolo, Bellevue, WA (US); Paul Forgey, Seattle, WA (US)

Correspondence Address: PERKINS COIE LLP;PATENT-SEA, P.O. BOX 1247, SEATTLE, WA, 98111-1247, US

(21) Appl. No.: 12/752,045

(22) Filed: Mar. 31, 2010

Related U.S. Application Data
(60) Provisional application No. 61/165,423, filed on Mar. 31, 2009.
(60) Provisional application No. 61/165,445, filed on Mar. 31, 2009.
(60) Provisional application No. 61/165,438, filed on Mar. 31, 2009.

(51) Int. Cl. G06F 15/173

(52) U.S. Cl. 709/224

(57) ABSTRACT

A facility for causing a device connected to a network that is configured to act as a DHCP server to enforce network health policies against hosts connected to the network is described. The device intercepts network packets sent to a DHCP server from any host connected to the network. For each of at least a portion of these intercepted network packets that contain a statement of health, the facility (1) applies a health policy to the contained statement of health to identify any network access controls required by the health policy in view of the contained statement of health, and (2) causes the identified network access controls to be composed on the host from which the intercepted network packet was received.

### CROSS-REFERENCE TO RELATED APPLICATIONS

This application claims priority to and incorporates by reference in its entirety U.S. Provisional Patent Application No. 61/165,423, entitled “Transparent Manipulation of DHCP Packets Containing SoH Data to Enforce Network Health Policies,” filed on Mar. 31, 2009.

This application is related to the following applications, each of which is hereby incorporated by reference in its entirety: U.S. Provisional Patent Application No. 61/165,445, entitled “Using In-the-Cloud Storage for Computer Health Data,” filed on Mar. 31, 2009; U.S. patent application Ser. No. ______ (patent counsel's docket no. 65985-8001US01), entitled “Using In-the-Cloud Storage for Computer Health Data,” filed concurrently herewith; U.S. Provisional Patent Application No. 61/165,438, entitled “Network-Assisted Health Reporting Activation,” filed on Mar. 31, 2009; and U.S. patent application Ser. No. ______ (patent counsel's docket no. 65985-8006US01), entitled “Network-Assisted Health Reporting Activation,” filed concurrently herewith.

### TECHNICAL FIELD

The described technology is directed to the field of computer networking, and, more particularly, to the field of network health.

### BACKGROUND

Network Access Control (NAC) technology provides the ability for a network appliance (such as an Ethernet switch) to enforce network access restrictions based on some administratively-defined access policy. These restrictions could include, for example, limiting the types of protocols, network services, servers, or other network devices that a connected device is permitted to access.

In a typical NAC deployment, the NAC enforcement appliance must make a decision about whether and how to enforce access control based on information the connected devices provide to the NAC enforcement appliance via the network. An example of this might be user-based authentication—the NAC device might only allow full network access if a user of the connecting device has authenticated to the network and has the appropriate access privileges.

DHCP provides a mechanism for network hosts on a network to obtain their IP configuration automatically from a server. Such a server is called a DHCP server, and hosts that use a DHCP server are called DHCP clients. The DHCP clients and DHCP servers communicate with each other via special UDP packets called DHCP packets. Well-defined pieces of data called DHCP options can be included in these DHCP packets. DHCP options are discussed in more detail in “BOOTPC/DHCP options,” RFC Sourcebook, available at http://www.networksorcery.com/enp/protocol/bootp/options.htm and pages linked therefrom, which are hereby all incorporated by reference in their entirety.

The DHCP server may be on the same network as the DHCP clients, or the DHCP server may be on another network, with communication between the DHCP clients and DHCP servers fielded by a DHCP relay agent, which is located on the same network as the DHCP clients and knows how to forward DHCP packets to the DHCP server. Additional details about DHCP are included in “Dynamic Host Configuration Protocol (DHCP),” RFC 2131, Internet Engineering Task Force, available at HTTP://www.ietf.org/rfc/rfc2131.txt, which is hereby incorporated by reference in its entirety.

Microsoft has defined a DHCP option containing information about a network host's software state called an SoH (Statement of Health). A system health agent installed on a host assesses the health state of the host and generates an SoH. This SoH contains information pertinent to the health of a network host, and thus an assessment of risk to other hosts on the same network. Typical information contained in an SoH includes:

Personal Internet Firewall—disabled, enabled, and/or a manifest of options/settings;

Anti-virus—disabled, enabled, or enabled and up-to-date, and/or a manifest of options/settings;

Anti-spyware—disabled, enabled, or enabled and up-to-date, and/or a manifest of options/settings;

OS Automatic Updates—disabled, enabled, or enabled and up-to-date (no outstanding vendor-recommended patches); and

Automatic Login—allowed or disallowed.

The network host sends the DHCP server its SoH data, and the DHCP server responds with an SoHR (Statement of Health Response), which informs the network host which aspects of the SoH it finds acceptable, and if the network host should be allowed to interact normally with other hosts on the same network. In doing so, the DHCP server is also functioning as a policy server, examining the SoH of the client and deciding whether or not is should be allowed on the network. System health agents are discussed in greater detail in [MS-WSH]: Windows Security Health Agent (WSHA) and Windows Security Health Validator (WSHV) Protocol Specification, available via links at http://msdn.microsoft.com/en-us/librarv/cc251347.aspx, which is hereby incorporated by reference in its entirety. Additional details about SoHs are included in [MS-SOH]: Statement of Health for Network Access Protection (NAP) Protocol Specification, available via links at http://msdn.microsoft.com/en-us/librarv/cc246924.aspx, which is hereby incorporated by reference in its entirety. Additional details about incorporating SoHs inside DHCP requests are discussed in [MS-DHCPN]: Dynamic Host Configuration Protocol (DHCP) Extensions for Network Access Protection (NAP), available via links at http://msdn.microsoft.com/en-us/library/cc227316.aspx, which is hereby incorporated by reference in its entirety. The encoding of an SoH and SoHR is discussed in greater detail in “NAP SoH Request and Response,” available at http://msdn.microsoft.com/en-us/library/aa506213.aspx, which is hereby incorporated by reference in its entirety.

Microsoft clients do not send an SoH in every request. Instead they look at the responses from a DHCP server to see if they contain an attribute that indicates the server can process SoH payloads. If this attribute is seen by the client, it will resend its DHCP request with the SoH present.

### BRIEF DESCRIPTION OF THE DRAWINGS

FIG. 1 is a block diagram illustrating some components of an environment in which the facility operates.

FIG. 2 is a block diagram showing some of the components typically incorporated in at least some of the computer systems and other devices on which the facility executes in some embodiments.

FIG. 3 is a data flow diagram showing a typical exchange of data between network nodes in accordance with the facility in some embodiments.

FIG. 4 is a flow diagram showing steps typically performed by the facility on the health inspection and enforcement node in some embodiments.

FIGS. 5A-5C are data structure diagrams each showing a different state of a flow established by the facility for the host featured in the example.

FIG. 6 is a table diagram showing a sample network health determination by the facility based upon the statement of health contained in the second DHCP request.

### DETAILED DESCRIPTION

The inventors have recognized that the conventional scheme for managing network health in a DHCP server has significant disadvantages. For example, in some networks, the DHCP server in use is incapable of acting as a health policy server, and is not even able to recognize SoHs. In some networks, the DHCP server in use recognizes SoHs and acts as a health policy server, but in a manner that is not optimal. For example, some DHCP servers are limited in one or more of the following ways: their flexibility for establishing network health policies; their user interface for managing network health policies; their ability to appropriately deliver network health deficiencies and other network health information; and their ability to store and process network health information persistently and reliably.

Accordingly, a software and/or hardware facility is described for intercepting network traffic containing network health information in a node of other than the node to which it is directed by system health agents, and performing health policy server responsibilities on the basis of the intercepted traffic (“the facility”). This interception obviates any need for the system health agents or other aspects of the hosts sending health information to be specifically configured to operate in connection with the facility.

In some embodiments, a health inspection and enforcement node is established in the network for intercepting network traffic containing network health information. In some embodiments, the health inspection and enforcement node is positioned between the DHCP server and the other hosts in the network in order to facilitate this interception.

In various embodiments, the health inspection and enforcement node: modifies DHCP responses produced by the DHCP server to suggest to the hosts that receive them that the DHCP server is capable of processing SoHs; for each DHCP request containing a SoH, extracts the SoH, uses the extracted SoH to make network health policy decisions for the sending host, and forwards the DHCP request to the DHCP server without the SoH; and, for each DHCP response to a host for which a network health policy decision has been made, adding to the DHCP response a SoHR reflecting the network health policy decision made for the host.

In some embodiments, the facility maintains a state for each host that includes a “flow” representing the interactions between the host and the DHCP server, and that includes or is connected to a health assessment and/or a health policy decision for the host.

By performing in some or all of these ways, the facility enables a network node other than the network node to which network health information is directed to act as a health policy server for the network.

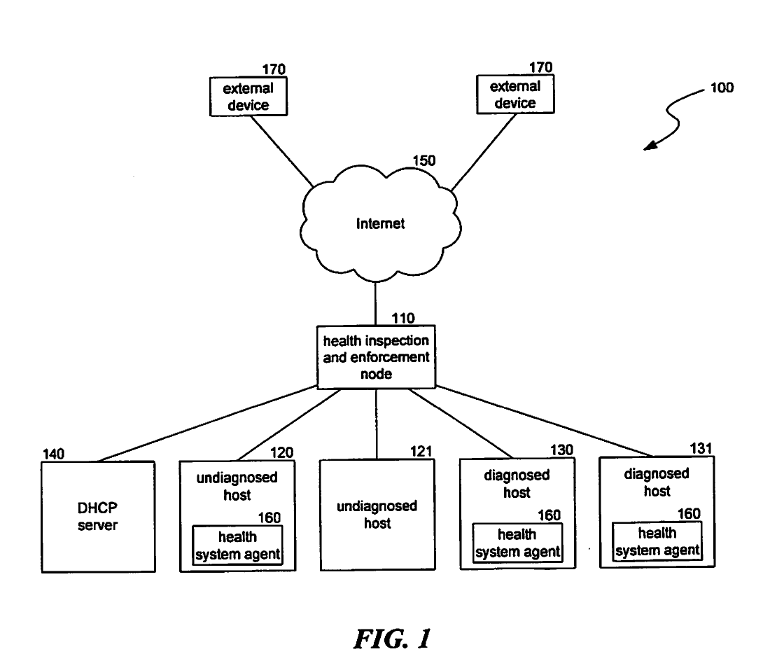

FIG. 1 is a block diagram illustrating some components of an environment 100 in which the facility operates in some embodiments. In this example, the environment 100 includes health inspection and enforcement node 110, undiagnosed hosts 120 and 121, diagnosed hosts 130 and 131, DHCP server 140, Internet 150, and external hosts 170. The DHCP server provides dynamic network addresses to hosts in the network using a DHCP protocol. In some embodiments, the DHCP server is a router. In this example, health inspection and enforcement node 110 inspects health information included in DHCP requests sent by undiagnosed hosts 120 and 121 and diagnosed hosts 130 and 131, or the “managed hosts,” and uses this health information to enforce health policies against the managed hosts. In some embodiments, the health inspection and enforcement node is a network switch situated between the managed hosts and the DHCP server in order to intercept DHCP requests traveling from the managed hosts to the DHCP server and DHCP responses traveling from the DHCP server to the managed nodes. The health inspection and enforcement node 110 also generates health diagnoses for managed hosts and a set of access privileges for those hosts based on an SoH received from each host. When the inspection and enforcement node determines that a managed host is unhealthy or undiagnosed, the inspection and enforcement node quarantines the host from the network to restrict that host's access to network components. The inspection and enforcement node 110 also monitors access requests from managed hosts and allows or denies those requests in accordance with access privileges associated with the host. Diagnosed hosts 130 and 131 are hosts for which the inspection and enforcement node has a valid health diagnosis while undiagnosed hosts 120 and 121 are hosts for which the inspection and enforcement node does not have a valid diagnosis. The inspection and enforcement node generates health diagnoses by processing an SoH sent from the host and generated by system health agent 160. In this example, undiagnosed host 121 does not include a system health agent and, therefore, has not provided an SoH to the inspection and enforcement node. Although undiagnosed host 120 includes a system health agent 160, the inspection and enforcement node does not have a valid diagnosis for the host because, for example, the system health agent is disabled or a previously generated diagnosis has expired. The inspection and enforcement node 160 may also manage communications between the managed hosts and other connected hosts such as server 140 or hosts that are not directly connected to the inspection and enforcement node, such as external hosts 170, via Internet 150. In some embodiments, the application of health policies and/or the enforcement of health policies is performed in one or more nodes separate from the node in which health inspection is performed.

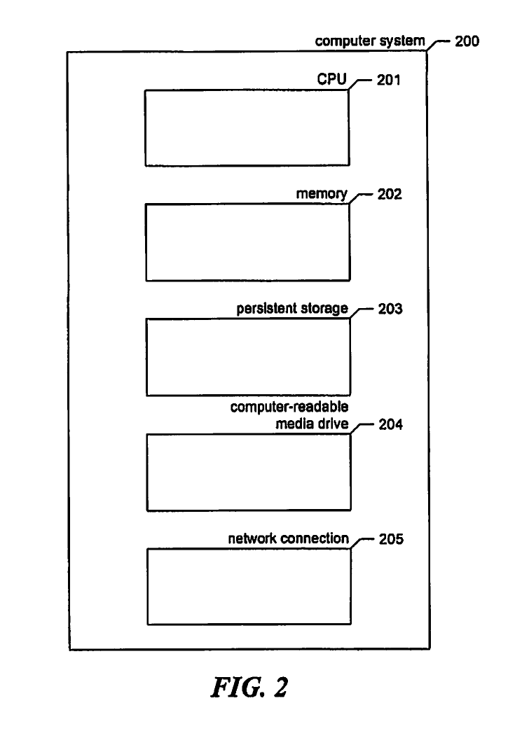

FIG. 2 is a block diagram showing some of the components typically incorporated in at least some of the computer systems and other hosts on which the facility executes in some embodiments. These computer systems and hosts 200 may include one or more central processing units (“CPUs”) 201 for executing computer programs; a computer memory 202 for storing programs and data—including data structures, database tables, other data tables, etc.—while they are being used; a persistent storage host 203, such as a hard drive, for persistently storing programs and data; a computer-readable media drive 204, such as a CD-ROM drive, for reading programs and data stored on a computer-readable medium; and a network connection 205 for connecting the computer system to other computer systems, such as via the Internet or another network and its networking hardware, to exchange programs and/or data—including data structures. In various embodiments, the facility can be accessed by any suitable user interface including Web services calls to suitable APIs. While computer systems configured as described above are typically used to support the operation of the facility, one of ordinary skill in the art will appreciate that the facility may be implemented using hosts of various types and configurations, and having various components, such as wireless telephones and similar hosts.

The computing device on which the facility is implemented may include input device (e.g., keyboard and pointing device), output device (e.g., display device), and storage device (e.g., disk drives, flash drives). The memory and storage device are computer-readable media that may be encoded with computer-executable instructions that implement the facility, which means a computer-readable medium that contains the instructions. In addition, the instructions, data structures, and message structures may be stored in a data storage medium or transmitted via a data transmission medium, such as a signal on a communications link, and may be encrypted. Various communications links may be used, such as the Internet, a personal area network, a local area network, a wide area network, a point-to-point dial-up connection, a cell phone network, and so on.

Embodiments of the facility may be implemented in and used with various operating environments that include personal computers, server computers, handheld or laptop device, multiprocessor systems, microprocessor-based systems, programmable consumer electronics, digital cameras, network PCs, minicomputers, mainframe computers, computing environments that include any of the above systems or device, and so on.

The facility may be described in the general context of computer-executable instructions, such as program modules, executed by one or more computers or other hosts. Generally, program modules include routines, programs, objects, components, data structures, and so on that perform particular tasks or implement particular abstract data types when executed by a processor. Typically, the functionality of the program modules may be combined or distributed as desired in various embodiments.

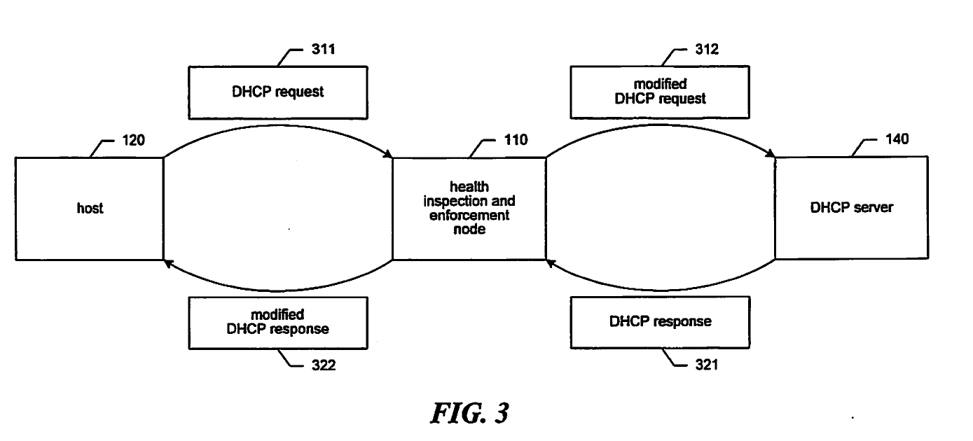

FIG. 3 is a data flow diagram showing a typical exchange of data between network nodes in accordance with the facility in some embodiments. A host 120 sends a DHCP request 311 that is addressed to a DHCP server 140. The DHCP request seeks assignment of a dynamic network address to the host 120 by the DHCP server. In some cases, the DHCP request includes a statement of health containing health information generated by a health system agent executing on the host. Rather than being delivered directly to the DHCP server, the DHCP request is intercepted by the health inspection and enforcement node 110. In some embodiments, the health inspection and enforcement node is a switch running software implementing the facility. The health inspection and enforcement node collects any statement of health or related health information from the DHCP request, which it uses to assess the health status of the host and make any appropriate health policy decisions for the host on the basis of its health status. The health inspection and enforcement node forwards a modified DHCP request 312 to the DHCP server. The modified DHCP request is a copy of the DHCP request from which health information has been removed. When the DHCP server receives the modified DHCP request, it sends a DHCP response 321 addressed to the host that assigns a dynamic IP address to the host. The DHCP response, rather than being directly delivered to the host, is intercepted by the health inspection and enforcement node. The health inspection and enforcement node uses the DHCP response to generate a modified DHCP response 322 containing health information for the host. For example, where the host has indicated that it can provide a statement of health, the modified DHCP response contains a prompt to the host to include a statement of health in its next DHCP request. Where the health inspection enforcement node has made health policy decisions for the host based upon one or more SoHs received from the host, the modified DHCP response includes a SoHR that reflects these health policy decisions. The health inspection and enforcement node forwards the modified DHCP response to the host.

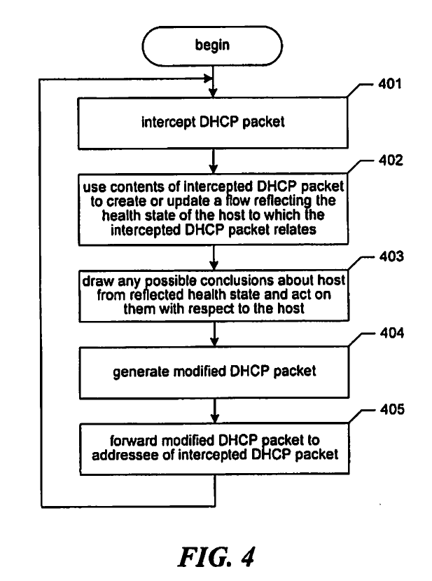

FIG. 4 is a flow diagram showing steps typically performed by the facility on the health inspection and enforcement node in some embodiments. In step 401, the facility intercepts a DHCP packet. The DHCP packet intercepted in step 401 may either be a DHCP request or a DHCP response. Where the health inspection and enforcement node is a network switch or a similar device, the facility intercepts these packets by installing a “protocol capturing” rule on the device having the following IP designation: IPv4, UDP, and port 67 or port 68. Where the health inspection and enforcement node is a device that contains hardware support for packet matching, the facility creates a protocol capturing rule in the native ACL language for this hardware support. Where the health inspection and enforcement node is a software appliance, in various embodiments, the facility uses a variety of software packet capture language APIs such as PCAP/BPF. The facility uses any of these interception mechanisms to trap original DHCP frames, as opposed to merely obtaining copies of them. If an intercepted packet contains a vendor option 43 that in turn contains NAT option 220, then the facility further processes the packet in step 402, else the facility permits the packet to pass without further processing (not shown).

In step 402, the facility uses the contents of the intercepted DHCP packet to create or update a flow reflecting the health state of the host to which the intercepted DHCP packet relates, that is, the host from which an intercepted DHCP request was sent or to which an intercepted DHCP response was sent. Step 402 involves parsing the NAP option 220 in vendor option 43 in the packet. Where the option 220 includes an SoH, option 220 includes a System Health Agent ID type that specifies the organization of the statement of health contained by option 220. The facility parses DHCP options as follows:

An array of 253 elements is created, numbered 1 to 254. Each element may contain NULL (no data), or anywhere between 0 and 65535 bytes of data. The DHCP option number corresponds to the array index. Options 0 (pad) and 255 (end) have special meaning and are not stored. It is important to note a difference between NULL and 0 bytes. NULL indicates the option is not present. If data of 0 bytes is stored, this indicates the option is present, but has a length of 0, therefore containing no data.

The DHCP options field is scanned (starting at byte offset 4 if the DHCP magic cookie is detected). If option 255 (end) is encountered, processing moves to the next step. If option 0 (pad) is encountered, that byte is ignored and scanning resumes as the next byte. In addition to encountering the end option, scanning also stops once the end of the packet (according to length) is encountered. For each option encountered other than 0, 250 or 255, data of the length indicated is copied and stored in the array at the proper index. If data is already present in the array at that index, it is appended. If option 250 is encountered, data is appended to the previous non-250 option's data and the fact option 250 was encountered is stored. If option 250 is encountered before any other options, its data is ignored.

If the DHCP overload option indicates the sname or file fields are used, the previous step is repeated for these fields. Data from a single instance of an option can not span multiple fields, which simplifies the algorithm to be re-applied to arbitrary fields of data. Just like parsing the main option data, if data is parsed in the overloaded fields, processing stops if option 255 (end) is encountered, or the end of the field. If both file and sname fields are overloaded, the file field is parsed before sname. If option 250 is encountered while processing data from an overloaded field, data from the last non-250 option is appended to even if it was not first encountered in the overloaded field.

The order in which individual options are first encountered is stored.

In step 403, the facility draws any possible conclusions about the host from the health state reflected by the updated flow, and acts on these conclusions with respect to the host. In step 404, the facility generates a modified DHCP packet, such as a modified DHCP request from which health information is removed, or a modified DHCP response, to which health information is added. Step 404 involves rewriting the intercepted packet as follows:

Using the stored order, options are written out to the options field. Options having a length of 0 are treated as it they are not present and are not written. If the message is not BOOTP, the DHCP message type option is always written first, followed by the overload option, if present. Writing to the options field stops once the maximum space has been taken, or there are no more options left to write. The maximum space in the options field is determined by the maximum transmission unit size of the network interface (MTU) being used to send the packet, or, if present, the maximum message size specified in the original DHCP message if it is smaller than what is allowed by the MTU.

If the space available in the options field is not sufficient to write all options and the message is not BOOTP, the DHCP overload option is written and indicates either file or both file and sname fields are to be overloaded. The algorithm used could overload only sname and not the file field, but this complicates the implementation with no reasonable benefit. If either file or sname contents are present but their fields are overloaded, their DHCP option equivalents are inserted instead before continuing to process the list of options. Option 255 (end) is always written at the end of a set of options within an overloaded field. If all option data is used and there are still options left to be written, then they are discarded. Partial option data is never written; if the entire option will not fit, it is not included at all.

In step 405, the facility forwards the modified DHCP packet generated in step 404 to the addressee of the intercepted DHCP packet. After step 405, the steps continue in step 401 to intercept the next DHCP packet.

Those skilled in the art will appreciate that the steps shown in FIG. 4 may be altered in a variety of ways. For example, the order of the steps may be rearranged; some steps may be performed in parallel; shown steps may be omitted, or other steps may be included; etc.

Tables 1-8 below portray an example of interactions between a host, the health inspection and enforcement node, and the DHCP server. Tables 1-4 show, respectively, a first DHCP request sent by the host that does not include a statement of health; the first DHCP request as modified by the health inspection and enforcement node; a first DHCP response sent by the DHCP server in response to receiving the modified first DHCP request; and a version of the first DHCP response modified by the health inspection and enforcement node. Tables 5-8 show, respectively, a second DHCP request sent by the host that does include a statement of health; the second DHCP request as modified by the health inspection and enforcement node; a second DHCP response sent by the DHCP server in response to receiving the modified second DHCP request; and a version of the second DHCP response modified by the health inspection and enforcement node.

First, the host sends the DHCP request packet shown below in Table 1, addressing it to the router that is serving as the DHCP Server for the network.

TABLE 1
first DHCP request

| | |
|---|---|
| 1. | 16:35:07.898000 IP (tos 0x0, ttl 128, id 28002, offset 0, flags [none], proto UDP (17), |
| | length 350) |
| 2. | 0.0.0.0.bootpc > broadcasthost.bootps: [bad udp cksum a60d!] BOOTP/DHCP, |
| | Request from 00:1d:ba:19:55:68 (oui Unknown), length 322, xid 0x2b52cada, secs |
| | 768, Flags [Broadcast] (0x8000) |
| 3. | Client-Ethernet-Address 00:1d:ba:19:55:68 (oui Unknown) |
| 4. | Vendor-rfc1048 Extensions |
| 5. | Magic Cookie 0x63825363 |
| 6. | DHCP-Message Option 53, length 1: Request |
| 7. | Client-ID Option 61, length 7: ether 00:1d:ba:19:55:68 |
| 8. | Requested-IP Option 50, length 4: 172.16.0.100 |
| 9. | Hostname Option 12, length 8: “WIN7VAIO” |
| 10. | FQDN Option 81, length 22: “WIN7VAIO.napera.com” |
| 11. | Vendor-Class Option 60, length 8: “MSFT 5.0” |
| 12. | Parameter-Request Option 55, length 12: |
| 13. | Subnet-Mask, Domain-Name, Default-Gateway, Domain-Name-Server |
| 14. | Netbios-Name-Server, Netbios-Node, Netbios-Scope, Router-Discovery |
| 15. | Static-Route, Classless-Static-Route, Classless-Static-Route-Microsoft, |
| | Vendor-Option |
| 16. | Vendor-Option Option 43, length 3: 220.1.0 |

Option 43 in line 16 contains Microsoft NAP option 220, whose value is one byte of value ‘0’. This indicates that the host is capable of sending SoH data.

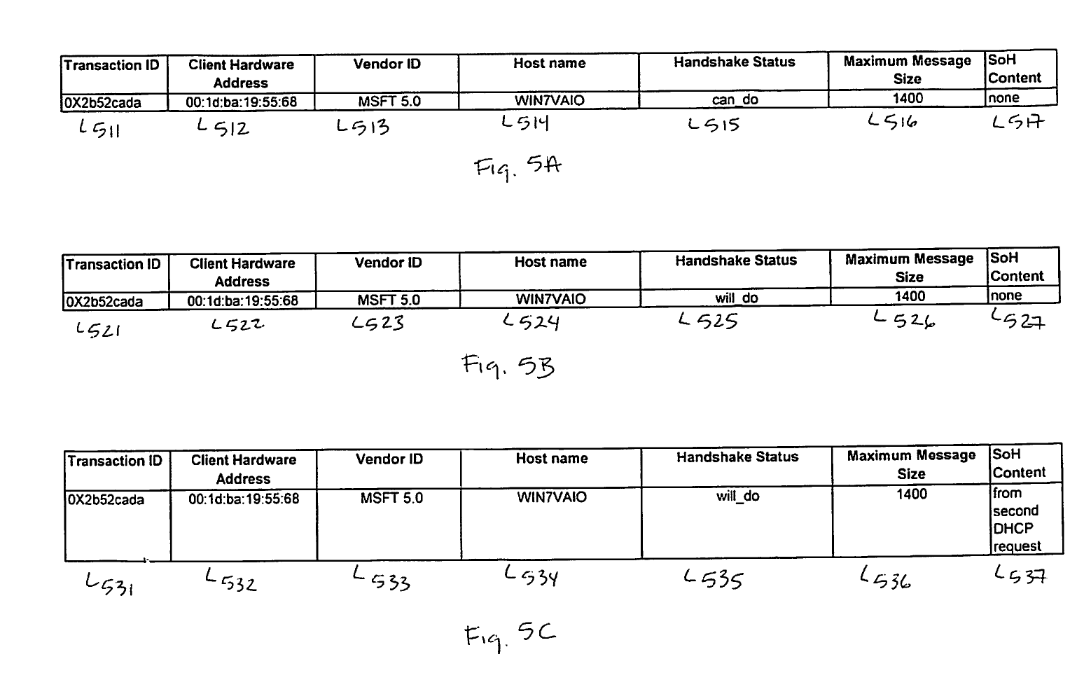

In response to receiving the first DHCP request package shown in Table 1, the facility establishes the flow shown in FIG. 5A. FIGS. 5A-5C are data structure diagrams each showing a different state of a flow established by the facility for the host featured in the example.

FIG. 5A shows the state of the flow when it is created by the facility in response to receiving the first DHCP request shown in Table 1. Contents of a transaction ID field 511 and a client hardware address field 512 are used as a key to identify this flow when subsequent packets in the same DHCP conversation are received from the host or the DHCP server. The transaction ID is extracted following the string “xid” in line 2 of Table 1, and the client ethernet address is extracted from line 3 of Table 1. The flow also contains two additional fields extracted directly from the packet: a vendor ID field 513, extracted from the vendor-class option 60 in line 11 of Table 1, and the host name field 514, extracted from host name option 12 in line 9 of Table 1. The flow further includes a handshake status field 525. This field contains one of three possible values: the value none indicates that the host has neither sent a statement of health nor indicated that it is capable of doing so; can_do indicates that the host has indicated that it is capable of sending an SoH; will_do indicates that the health inspection and enforcement node has requested a statement of health from the host, or that the host has already sent a statement of health. In response to the packet shown in Table 1, the facility sets the handshake status to can_do, based upon indication in line 16 of Table 1, in vendor-option option 43 within Microsoft NAP option 220 that the host is capable of sending a SoH. If the packet in Table 1 contained an indication of maximum message size, it would be stored in maximum message size field 516. Here, because the packet shown in Table 1 does not have a maximum message size, a default value of 1400 is stored in field 516. The flow also includes an SoH content field 517. Because the packet shown in Table 1 does not include a statement of health, this field is empty.

While FIG. 5A and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

In addition to storing the flow shown in FIG. 5A, in response to the first DHCP request packet from Table 1, the facility generates a modified first DHCP request packet shown below in Table 2.

TABLE 2
modified first DHCP request

| | |
|---|---|
| 1. | 16:37:23.018270 IP (tos 0x0, ttl 255, id 55325, offset 0, flags [none], proto UDP (17), |
| | length 345) |
| 2. | 0.0.0.0.bootpc > broadcasthost.bootps: [udp sum ok] BOOTP/DHCP, Request from |
| | 00:1d:ba:19:55:68 (oui Unknown), length 317, xid 0x2b52cada, secs 768, Flags |
| | [Broadcast] (0x8000) |
| 3. | Client-Ethernet-Address 00:1d:ba:19:55:68 (oui Unknown) |
| 4. | Vendor-rfc1048 Extensions |
| 5. | Magic Cookie 0x63825363 |
| 6. | DHCP-Message Option 53, length 1: Request |
| 7. | Client-ID Option 61, length 7: ether 00:1d:ba:19:55:68 |
| 8. | Requested-IP Option 50, length 4: 172.16.0.100 |
| 9. | Hostname Option 12, length 8: “WIN7VAIO” |
| 10. | FQDN Option 81, length 22: “WIN7VAIO.napera.com” |
| 11. | Vendor-Class Option 60, length 8: “MSFT 5.0” |
| 12. | Parameter-Request Option 55, length 12: |
| 13. | Subnet-Mask, Domain-Name, Default-Gateway, Domain-Name-Server |
| 14. | Netbios-Name-Server, Netbios-Node, Netbios-Scope, Router-Discovery |
| 15. | Static-Route, Classless-Static-Route, Classless-Static-Route-Microsoft, |
| | Vendor-Option |

It can be seen that the modified first DHCP request packet shown in Table 2 is a copy of the first DHCP request packet shown in Table 1, but without line 16 of Table 1 containing the NAP vendor option. If options other than 220 were contained in option 43, then option 43 would be present in this packet with those other options still intact. Since the SoH option 220 is the only option contained by option 43, option 43 is removed completely.

In response to receiving the modified first DHCP request packet shown in Table 2, the DHCP server replies with a first DHCP response assigning a dynamic address to the host. The first DHCP response is shown below in Table 3.

TABLE 3
first DHCP response

| | |
|---|---|
| 1. | 16:37:23.020677 IP (tos 0x10, ttl 128, id 0, offset 0, flags [none], proto UDP (17), |
| | length 328) |
| 2. | 172.16.0.1.bootps > broadcasthost.bootpc: [udp sum ok] BOOTP/DHCP, Reply, |
| | length 300, xid 0x2b52cada, secs 768, Flags [Broadcast] (0x8000) |
| 3. | Your-IP 172.16.0.100 |
| 4. | Server-IP 172.16.0.1 |
| 5. | Client-Ethernet-Address 00:1d:ba:19:55:68 (oui Unknown) |
| 6. | Vendor-rfc1048 Extensions |
| 7. | Magic Cookie 0x63825363 |
| 8. | DHCP-Message Option 53, length 1: ACK |
| 9. | Server-ID Option 54, length 4: 172.16.0.1 |
| 10. | Lease-Time Option 51, length 4: 600 |
| 11. | Subnet-Mask Option 1, length 4: 255.255.0.0 |
| 12. | Domain-Name Option 15, length 10: “napera.com” |
| 13. | Default-Gateway Option 3, length 4: 172.16.0.254 |
| 14. | Domain-Name-Server Option 6, length 4: 10.0.0.232 |

The dynamic address assigned to the host is shown in line 3 of Table 3. In response to receiving the first DHCP response shown in Table 3, the facility matches the first DHCP response to the flow shown in FIG. 5A, based upon it having the same transaction ID and client hardware address. Based upon the present handshake status of can_do in the flow, the facility modifies the received DHCP response by adding a vendor option specifying that the host should include a statement of health in future DHCP responses. The facility sends this modified DHCP response, shown in Table 4 below, to the host.

TABLE 4
modified first DHCP response

| | |
|---|---|
| 1. | 16:35:07.913600 IP (tos 0x0, ttl 255, id 62058, offset 0, flags [none], proto UDP (17), |
| | length 321) |
| 2. | 172.16.0.1.bootps > broadcasthost.bootpc: [udp sum ok] BOOTP/DHCP, Reply, |
| | length 293, xid 0x2b52cada, secs 768, Flags [Broadcast] (0x8000) |
| 3. | Your-IP 172.16.0.100 |
| 4. | Server-IP 172.16.0.1 |
| 5. | Client-Ethernet-Address 00:1d:ba:19:55:68 (oui Unknown) |
| 6. | Vendor-rfc1048 Extensions |
| 7. | Magic Cookie 0x63825363 |
| 8. | DHCP-Message Option 53, length 1: ACK |
| 9. | Server-ID Option 54, length 4: 172.16.0.1 |
| 10. | Lease-Time Option 51, length 4: 600 |
| 11. | Subnet-Mask Option 1, length 4: 255.255.0.0 |
| 12. | Domain-Name Option 15, length 10: “napera.com” |
| 13. | Default-Gateway Option 3, length 4: 172.16.0.254 |
| 14. | Domain-Name-Server Option 6, length 4: 10.0.0.232 |
| 15. | Vendor-Option Option 43, length 5: 220.3.78.65.80 |

It can be seen that, in the modified first DHCP response shown in Table 4, option 43 contains Microsoft NAP option 220, whose value is three bytes containing the ASCII values for ‘NAP,’ indicating to the host that it should include SoHs in future DHCP requests. FIG. 5B is a table diagram showing how the facility updates the flow for the host to reflect sending the modified first DHCP response shown in Table 4 indicating that the host should include SoHs in future DHCP requests. It can be seen that the facility has updated the handshake status 525 in the flow from the prior value can_do to a new value will_do.

At a later time, the host sends a second DHCP request shown below in Table 5.

TABLE 5
second DHCP request

| | |
|---|---|
| 1. | 16:35:07.929200 IP (tos 0x0, ttl 128, id 28004, offset 0, flags [none], proto UDP (17), |
| | length 712) |
| 2. | 0.0.0.0.bootpc > broadcasthost.bootps: [bad udp cksum 31cf!] BOOTP/DHCP, |
| | Request from 00:1d:ba:19:55:68 (oui Unknown), length 684, xid 0x2b52cada, secs |
| | 768, Flags [Broadcast] (0x8000) |
| 3. | Client-Ethernet-Address 00:1d:ba:19:55:68 (oui Unknown) |
| 4. | Vendor-rfc1048 Extensions |
| 5. | Magic Cookie 0x63825363 |
| 6. | DHCP-Message Option 53, length 1: Request |
| 7. | Client-ID Option 61, length 7: ether 00:1d:ba:19:55:68 |
| 8. | Requested-IP Option 50, length 4: 172.16.0.100 |
| 9. | Hostname Option 12, length 8: “WIN7VAIO” |
| 10. | FQDN Option 81, length 22: “WIN7VAIO.napera.com” |
| 11. | Vendor-Class Option 60, length 8: “MSFT 5.0” |
| 12. | Parameter-Request Option 55, length 12: |
| 13. | Subnet-Mask, Domain-Name, Default-Gateway, Domain-Name-Server |
| 14. | Netbios-Name-Server, Netbios-Node, Netbios-Scope, Router-Discovery |
| 15. | Static-Route, Classless-Static-Route, Classless-Static-Route-Microsoft, |
| | Vendor-Option |
| 16. | Vendor-Option Option 43, length 255: [SoH data inside option 220, |
| | unrelated option 222 is also present] |
| 17. | T250 Option 250, length 108: [rest of option 43] |

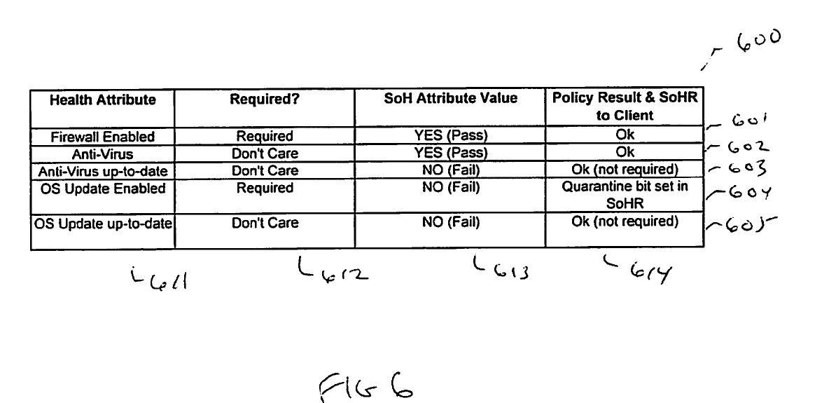

The second DHCP request shown in Table 5 contains a statement of health for the host in line 16, inside option 220, which is in turn inside option 43. In response to receiving the second DHCP request shown in Table 5, the facility updates its flow for this host, performs a health policy determination for this host, and forwards a modified version of the DHCP request to the DHCP server. FIG. 5C shows the facility's modification of the flow for this host in response to receiving the second DHCP request. It can be seen that the SoH content field 537 has been updated with the SoH data contained by the second DHCP request. The facility uses this SoH data to make a health policy determination for the host as discussed below in connection with FIG. 6.

FIG. 6 is a table diagram showing a sample network health determination by the facility based upon the statement of health contained in the second DHCP request. In the table 600, each row 601-605 corresponds to a different health attribute. Each row is divided into the following columns: a health attribute column 611 that identifies the health attribute to which the row corresponds; a required question mark column 612 that indicates whether the network health policy currently in force requires the health attribute to which the row corresponds to have the appropriate value in order to satisfy the health policy; an SoH attribute value column 613 that shows, for the attribute to which the row corresponds, the value contained for the attributed in the received statement of health, and an indication of whether that value is appropriate (pass) or inappropriate (fail), and a policy result and SoHR to client column 614 that shows whether the corresponding attribute is a basis for network health enforcement, either by specifying remediation actions in the SoHR that is sent to the host or by providing enforcement instructions for the host to another enforcement agent. For example, row 601 shows that the host has an appropriate value for the fire wall enabled attribute; row 603 shows that the host has an inappropriate value for the anti-virus up-to-date attribute, but that it does not affect the policy result because an appropriate value for this attribute is not required according to the current health policy; and that the host's value for the OS update enabled attribute is inappropriate, and the host will be quarantined because this attributed is required by the current health policy.

The facility further generates a modified DHCP request by reformulating vendor option 43 contained in lines 16-17 of Table 5 to exclude the statement of health data that is inside option 220, which is in turn inside option 43.

Despite RFC 3396, Microsoft uses a proprietary option 250 (“Continue”) to encode oversized options. There is an expired standards draft for this option. The facility is prepared to handle oversized options using either form, and will retransmit or answer using the method originated by the peer. The complete contents of option 43 is found by concatenating option 43 with option 250.

This example also shows option 43 being too big to fit in a standard DHCP option limited to 255 bytes. It is also important to point out the Microsoft option 220 is a vendor option inside option 43, so to decode the oversized data, the facility first reassembles option 43, and uses that data to reassemble option 220. Simply concatenating the raw data from option 43 and option 250 will not produce an intact option 220.

Accordingly, the facility arrives at the modified second DHCP request shown below in Table 6.

TABLE 6
modified second DHCP request

| | |
|---|---|
| 1. | 16:37:27.164500 IP (tos 0x0, ttl 255, id 49232, offset 0, flags [none], proto UDP (17), |
| | length 473) |
| 2. | 172.16.0.100.bootpc > 172.16.0.1.bootps: [udp sum ok] BOOTP/DHCP, Request |
| | from 00:1d:ba:19:55:68 (oui Unknown), length 445, xid 0x3e488db0, Flags [none] |
| | (0x0000) |
| 3. | Client-IP 172.16.0.100 |
| 4. | Client-Ethernet-Address 00:1d:ba:19:55:68 (oui Unknown) |
| 5. | Vendor-rfc1048 Extensions |
| 6. | Magic Cookie 0x63825363 |
| 7. | DHCP-Message Option 53, length 1: Request |
| 8. | Client-ID Option 61, length 7: ether 00:1d:ba:19:55:68 |
| 9. | Hostname Option 12, length 8: “WIN7VAIO” |
| 10. | FQDN Option 81, length 22: “WIN7VAIO.napera.com” |
| 11. | Vendor-Class Option 60, length 8: “MSFT 5.0” |
| 12. | Parameter-Request Option 55, length 12: |
| 13. | Subnet-Mask, Domain-Name, Default-Gateway, Domain-Name-Server |
| 14. | Netbios-Name-Server, Netbios-Node, Netbios-Scope, Router-Discovery |
| 15. | Static-Route, Classless-Static-Route, Classless-Static-Route-Microsoft, |
| | Vendor-Option |
| 16. | Vendor-Option Option 43, length 132: [unrelated option 222] |

In response to receiving the modified second DHCP request, the DHCP server replies with a second DHCP response shown below in Table 7.

TABLE 7
second DHCP response

| | |
|---|---|
| 1. | 16:37:27.167102 IP (tos 0x0, ttl 64, id 0, offset 0, flags [DF], proto UDP (17), length |
| | 328) |
| 2. | 172.16.0.1.bootps > 172.16.0.100.bootpc: [bad udp cksum 5cf8!] BOOTP/DHCP, |
| | Reply, length 300, xid 0x3e488db0, Flags [none] (0x0000) |
| 3. | Client-IP 172.16.0.100 |
| 4. | Your-IP 172.16.0.100 |
| 5. | Server-IP 172.16.0.1 |
| 6. | Client-Ethernet-Address 00:1d:ba:19:55:68 (oui Unknown) |
| 7. | Vendor-rfc1048 Extensions |
| 8. | Magic Cookie 0x63825363 |
| 9. | DHCP-Message Option 53, length 1: ACK |
| 10. | Server-ID Option 54, length 4: 172.16.0.1 |
| 11. | Lease-Time Option 51, length 4: 600 |
| 12. | Subnet-Mask Option 1, length 4: 255.255.0.0 |
| 13. | Domain-Name Option 15, length 10: “napera.com” |
| 14. | Default-Gateway Option 3, length 4: 172.16.0.254 |
| 15. | Domain-Name-Server Option 6, length 4: 10.0.0.232 |

In response to receiving the second DHCP response in the health inspection and enforcement node, the facility matches the second DHCP response to the flow for the host shown in FIG. 5C. Based upon the SoH content field 537 being non-empty, the facility uses the health policy determination made for the host in response to receiving the host's statement of health in the second DHCP request to generate an SoHR. The facility adds this SoHR data to the second DHCP response in order to obtain the modified second DHCP response, shown below in Table 8, and forwarded to the host. It can be seen that this SoHR is contained in line 15 of Table 8.

TABLE 8
modified DHCP response

| | |
|---|---|
| 1. | 16:35:07.960400 IP (tos 0x0, ttl 255, id 57949, offset 0, flags [none], proto UDP (17), |
| | length 523) |
| 2. | 172.16.0.1.bootps > broadcasthost.bootpc: [udp sum ok] BOOTP/DHCP, Reply, |
| | length 495, xid 0x2b52cada, secs 768, Flags [Broadcast] (0x8000) |
| 3. | Your-IP 172.16.0.100 |
| 4. | Server-IP 172.16.0.1 |
| 5. | Client-Ethernet-Address 00:1d:ba:19:55:68 (oui Unknown) |
| 6. | Vendor-rfc1048 Extensions |
| 7. | Magic Cookie 0x63825363 |
| 8. | DHCP-Message Option 53, length 1: ACK |
| 9. | Server-ID Option 54, length 4: 172.16.0.1 |
| 10. | Lease-Time Option 51, length 4: 600 |
| 11. | Subnet-Mask Option 1, length 4: 255.255.0.0 |
| 12. | Domain-Name Option 15, length 10: “napera.com” |
| 13. | Default-Gateway Option 3, length 4: 172.16.0.254 |
| 14. | Domain-Name-Server Option 6, length 4: 10.0.0.232 |
| 15. | Vendor-Option Option 43, length 207: [SoHR data inside option 220] |

When the host receives this modified second DHCP response, the SoHR that it contains is passed to the system health agent on the host for use in enforcing the network health determination contained in the SoHR.

In various embodiments, the facility uses various approaches to enforce its network health determination for a host. This can involve invoking the assistance of other enforcement entities in the network. This can involve modifying other areas of the DHCP response before forwarding it to the host, including setting a very short lease time (overriding what the server sets in its response); or putting the client on a different IP subnet; or giving the client an alternate default gateway (such as one that applies more strict Internet-access rules); etc.

Each time the host is changed in a way that affects the health system agent's health assessment of the host, the health system agent causes a new DHCP request to be sent containing a new SoH for the host. When the new SoH is received in the health inspection and enforcement node, it is evaluated in accordance with the then-current network health policy and a new network health determination is made for the node. Any changes in this new network health determination for the node are reflected in the health enforcement measured with respect to the node, both those that are performed by the health system agent based upon instructions in SoHRs received by the health system agent and by other enforcement measures. Therefore, if the health attributed values in the earlier statement of health that were the basis for health enforcement against the host are remedied in the health attribute values in the new statement of health, the rights of the host are expanded to reflect this new level of healthiness.

In some embodiments, the facility provides a configuration switch that may be used by an administrator to disable the interception of DHCP packets by the facility and its modification of these packets.

It will be appreciated by those skilled in the art that the above-described facility may be straightforwardly adapted or extended in various ways. For example, the facility can be straightforwardly adapted to intercept datagrams of various types other than DHCP packets to extract and/or insert health information. While the foregoing description makes reference to particular embodiments, the scope of the invention is defined solely by the claims that follow and the elements recited therein.

We claim:

1. A computer-readable medium whose contents are capable of causing a device connected to a network that is not configured to act as a DHCP server to perform a method for enforcing network health policies against hosts connected to the network, the method comprising:
intercepting network packets sent to a DHCP server from any host connected to the network; and
for each of at least a portion of the intercepted network packets sent to a DHCP server that contain a statement of health:
applying a health policy to the contained statement of health to identify any network access controls required by the health policy in view of the contained statement of health; and
causing the identified network access controls to be imposed on the host from which the intercepted network packet was received.

2. The computer-readable medium of claim 1 wherein the identified network access controls each specify handling for one or more types of traffic, and wherein the device causes the identified network access controls to be imposed on each host for which network access controls have been identified by:
intercepting traffic from the host of any of the types specified by network access controls identified for the host; and
handling the intercepted traffic in accordance with the network access controls identified for the host.

3. The computer-readable medium of claim 2 wherein the handling comprises modifying the intercepted traffic before forwarding it to its destination.

4. The computer-readable medium of claim 2 wherein the handling comprises omitting to forward the intercepted traffic to its destination.

5. The computer-readable medium of claim 2 wherein the handling comprises forwarding the intercepted traffic to its destination unchanged if contents of the intercepted traffic satisfy a condition associated with the network access controls identified for the host.

6. The computer-readable medium of claim 2 wherein the handling comprises forwarding a modified copy of the intercepted traffic to its destination if contents of the intercepted traffic satisfy a condition associated with the network access controls identified for the host.

7. The computer-readable medium of claim 2 wherein the handling comprises omitting to forward the intercepted traffic to its destination if contents of the intercepted traffic satisfy a condition associated with the network access controls identified for the host.

8. The computer-readable medium of claim 1 wherein the device causes the identified network access controls to be imposed on each host for which network access controls have been identified by forwarding to a policy enforcement device attached to the network that is distinct from the device performing the method, for each host for which network access controls have been identified, (a) information identifying the host, and (b) an indication of the network access controls identified for the host.

9. The computer readable medium of claim 1, further comprising, for each of the intercepted network packets sent to a DHCP server that contain a statement of health, forwarding a copy of the intercepted network packet from which the statement of health has been removed to the DHCP server to which the intercepted network packet was addressed.

10. The computer-readable medium of claim 1, the method further comprising:
for each of at least a portion of the intercepted network packets sent to a DHCP server that contain a statement of health, generating a statement of health response for the host from which the intercepted network packet was received;
intercepting network packets sent from a DHCP server to any host connected to the network; and
for each intercepted network packet sent from a DHCP server to a host for which a statement of health response has been received, forwarding to the host a copy of the intercepted network packet to which the generated statement of health response has been added.

11. The computer-readable medium of claim 1, the method further comprising:
intercepting network packets sent from a DHCP server to any host connected to the network; and
for each of at least a portion of the intercepted network packets sent to a DHCP server that do not contain a statement of health, when a network packet sent from a DHCP server to any host connected to the host is intercepted, forwarding to the host a copy of the intercepted network packet to which has been added an indication that the DHCP server from which the network packet was sent can process statements of health.

12. The computer-readable medium of claim 1 wherein the method is only performed in response to determining that no NAP server is operating in the network.

13. A networking device comprising:
an interface for connecting to a plurality of devices;
a first interception subsystem that intercepts datagrams of a first type sent from devices connected to the interface that contain statements of health, each intercepted datagram of the first type specifying a destination device;
a removal subsystem that removes each statement of health contained by a datagram intercepted by the first interception subsystem; and
a first forwarding subsystem that forwards each datagram of the first type intercepted by the first interception subsystem to the destination device specified by the datagram, wherein the forwarded datagram is the datagram after removal of its statement of health by the removal subsystem.

14. The networking device of claim 13, further comprising a storage subsystem that stores each removed statement of health together with information identifying the device that sent the datagram from which the statement of health was removed.

15. The networking device of claim 13, further comprising a distribution subsystem that forwards to a connected device each removed statement of health together with information identifying the device that sent the datagram from which the statement of health was removed.

16. The networking device of claim 13, further comprising a health policy management subsystem that, for each statement of health removed by the removal subsystem, applies a set of health policies to the statement of health to produce a health policy decision for the device from which the datagram from which the statement of health was removed was sent.

17. The networking device of claim 13, further comprising a health policy enforcement subsystem that, for each health policy decision produced by applying a set of health policies to the statement of health for the device from which the datagram from which the statement of health was removed was sent, enforcing the health policy decision against the device.

18. The networking device of claim 13, further comprising:
a second interception subsystem that intercepts datagrams of a second type sent to devices connected to the interface, each intercepted datagram of the second type specifying a destination device;
an addition subsystem that adds to each of at least a portion of the datagrams of the second type intercepted by the second interception subsystem a statement of health response reflecting a health policy decision produced for the destination device specified by the datagram of the second type; and
a second forwarding subsystem that forwards each datagram of the second type intercepted by the second interception subsystem to the destination device specified by the datagram, wherein the forwarded datagram is the datagram after addition of any statement of health response by the addition subsystem.

19. A method in a computing system, comprising:
intercepting a packet sent by a device and addressed to a network server;
extracting from the intercepted packet information about the health of the sending device; and
forwarding a version of the intercepted packet from which the extracted information has been removed to the network server.

20. The method of claim 19, further comprising, on the basis of the extracted health information, determining that the sending device should be denied access to at least one network resource.

21. The method of claim 19, further comprising, on the basis of the determination, denying the sending device access to at least one network resource.

22. A method in a computing system, comprising:
intercepting a DHCP packet containing DHCP options sent by a device and addressed to a DHCP server;
parsing all of the DHCP options contained by the packet;
for each of one or more selected DHCP options among the parsed DHCP options, modifying the DHCP option, to obtain a modified DHCP packet;
forwarding the modified DHCP packet to the DHCP server to which the intercepted DHCP packet was addressed.

23. The method of claim 22 wherein, for at least one of the selected DHCP options, modifying the DHCP option comprises deleting the DHCP option.

24. The method of claim 22 wherein, for each of at least one of the selected DHCP options, the DHCP option has contents, and
wherein, for each of at least one of the selected DHCP options having contents, modifying the DHCP option comprises modifying the contents of the DHCP option.

25. The method of claim 22, further comprising, as part of obtaining the modified DHCP packet, adding to the DHCP packet a DHCP option that contained by the DHCP packet at the time of its interception.

26. A networking hardware device conveying a DHCP request data structure relating to an original DHCP request data structure generated by a sender network node, the original DHCP request data structure comprising:
information identifying the sender network node;
information requesting assignment of a dynamic network address to the sender
network node; and
information conveying health attribute values of the sender network node,
the DHCP request data structure comprising:
the information identifying a sender network node; and
the information requesting assignment of a dynamic network address to the sender network node,
the DHCP request data structure omitting the information conveying health attribute values of the sender network node,
such that a receiver of the DHCP request data structure can respond to a request for some of a dynamic network address without receiving the information conveying health attribute values of the sender network node.

27. One or more computer memories collectively storing a DHCP response data structure relating to an original DHCP response data structure generated by a DHCP server, the original DHCP response data structure comprising:
information identifying a network node; and
information specifying a dynamic network address assigned to the identified network node,
the original DHCP response data structure omitting any information specifying network health remediation instructions to be carried out by the identified network node,
the DHCP response data structure comprising:
information identifying a network node;
information specifying a dynamic network address assigned to the identified network node; and
information specifying network health remediation instructions to be carried out by the identified network node,
such that, when the DHCP response data structure is received by the identified network node, the identified network node can carry out the network health remediation instructions despite the fact that they were not included in the original DHCP response data structure generated by the DHCP server.
